(19) United States
(12) Patent Application Publication
(10) Pub. No.: US 2024/0322737 A1
(43) Pub. Date: Sep. 26, 2024

(54) COOLING SYSTEM AND MOVING OBJECT

(71) Applicant: HONDA MOTOR CO., LTD., Tokyo (JP)

(72) Inventors: Hikari Hirayanagi, Wako-shi (JP); Yuichi Fukuchi, Wako-shi (JP); Takuya Kubota, Wako-shi (JP); Azuki Ichikawa, Wako-shi (JP)

(21) Appl. No.: 18/605,143

(22) Filed: Mar. 14, 2024

(30) Foreign Application Priority Data
Mar. 20, 2023 (JP) 2023-044185

(51) Int. Cl. H02P 29/64; B64D 33/10

(52) U.S. Cl. CPC H02P 29/64; B64D 33/10

(57) ABSTRACT

A cooling system includes: an acquisition unit that acquires information about the rotational speed of a rotating electric machine and information about the torque of the rotating electric machine; a cooling device that cools a cooling target; and a control unit that controls the cooling device based on a feedforward value generated based on the rotational speed and the torque.

### CROSS-REFERENCE TO RELATED APPLICATIONS

This application is based upon and claims the benefit of priority from Japanese Patent Application No. 2023-044185 filed on Mar. 20, 2023, the contents of which are incorporated herein by reference.

### BACKGROUND OF THE INVENTION

### Field of the Invention

The present invention relates to a cooling system and a moving object.

### Description of the Related Art

When a current flows through a rotating electric machine (electric motor, generator, or the like), the rotating electric machine generates heat due to loss (copper loss, iron loss, mechanical loss, or the like). JP 6690885 B2 discloses a control device for cooling an electric motor using a cooling medium that has been cooled by cooling fans.

### SUMMARY OF THE INVENTION

However, the control device disclosed in JP 6690885 B2 cannot necessarily perform cooling control satisfactorily.

An object of the present invention is to solve the above-mentioned problem.

A cooling system of the present invention is a cooling system that cools a cooling target including a rotating electric machine, and comprises: an acquisition unit configured to acquire information about a rotational speed of the rotating electric machine, and information about torque of the rotating electric machine; a cooling device configured to cool the cooling target; and a control unit configured to control the cooling device based on a feedforward value generated based on the rotational speed and the torque.

A moving object of the present invention comprises the above-described cooling system.

According to the present invention, the accuracy of the cooling control for the rotating electric machine can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a moving object;

FIG. 2 is a block diagram showing a configuration of a cooling system according to a first embodiment;

FIG. 3 is a schematic view of a motor;

FIG. 4 is an explanatory diagram for explaining a thermal model of the motor;

FIG. 5 is a flowchart of a cooling process according to the first embodiment;

FIG. 6 is a block diagram of feedforward control and feedback control according to the first embodiment;

FIG. 7 is a block diagram of feedforward control and feedback control according to a modification of the first embodiment;

FIG. 8 is a block diagram showing a configuration of a cooling system according to a second embodiment;

FIG. 9 is a flowchart of a cooling process according to the second embodiment;

FIG. 10 is a block diagram of feedforward control and feedback control according to the second embodiment;

FIG. 11 is a flowchart of a cooling process according to a first modification of the second embodiment;

FIG. 12 is a block diagram of feedforward control and feedback control according to the first modification of the second embodiment;

FIG. 13 is a flowchart of a cooling process according to a second modification of the second embodiment; and

FIG. 14 is a block diagram of feedforward control and feedback control according to the second modification of the second embodiment.

### DETAILED DESCRIPTION OF THE INVENTION

The control device disclosed in JP 6690885 B2 performs feedforward control based on the current flowing through the electric motor. However, even when the same current flows through the electric motor, the rotational speed of the electric motor may be different. Therefore, it is difficult to cool the electric motor with high accuracy based on the current flowing through the electric motor.

### 1. Target for which Cooling System 14 is Used

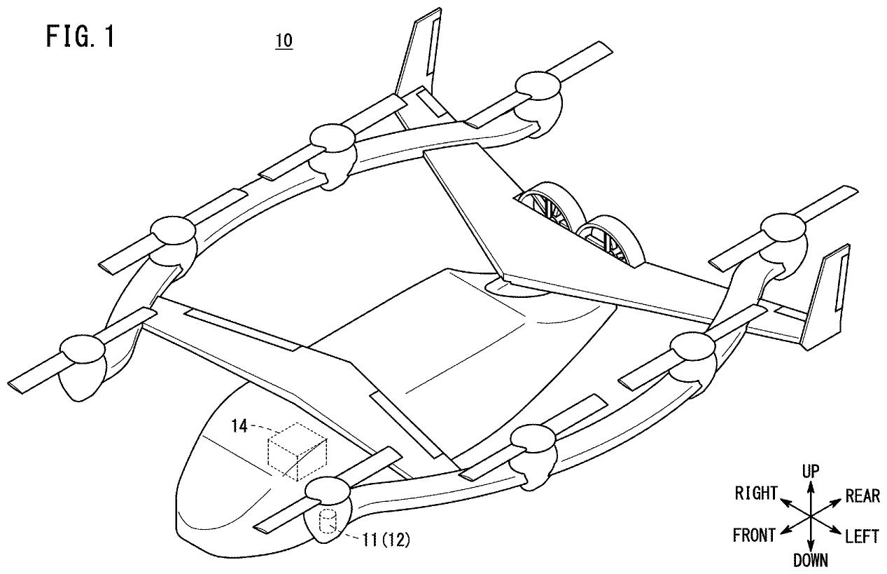

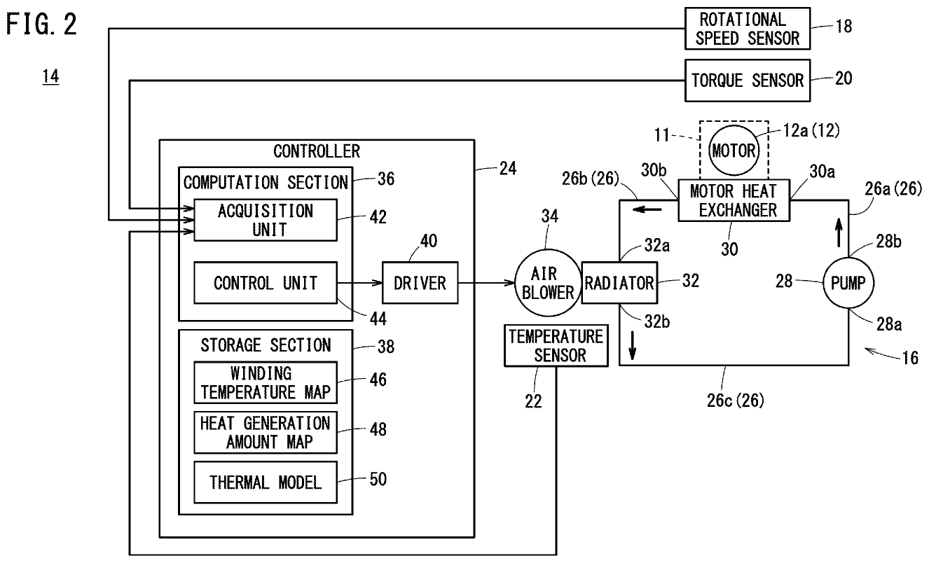

FIG. 1 is a schematic view of a moving object 10. The moving object 10 shown in FIG. 1 is an electric vertical takeoff and landing aircraft (eVTOL aircraft). The eVTOL aircraft includes a cooling target 11 and a cooling system 14. The cooling system 14 cools the cooling target 11 including a rotating electric machine 12. The eVTOL aircraft includes the rotating electric machine 12 such as a motor 12a (FIG. 2) and a generator. The motor 12a rotates rotors (VTOL rotors or cruise rotors). The generator supplies electric power to a battery or the motor 12a.

The apparatus on which the cooling system 14 is mounted is not limited to the eVTOL aircraft. The cooling system 14 can be used for all apparatuses including the rotating electric machine 12. For example, the cooling system 14 may be used for the moving object 10 other than the eVTOL aircraft (such as an aircraft, a vehicle, a ship, and a train). Further, the cooling system 14 may be used for an apparatus including the rotating electric machine 12 and used in a home, a factory, or the like.

### 2. First Embodiment

### [2-1. Configuration of Cooling System 14]

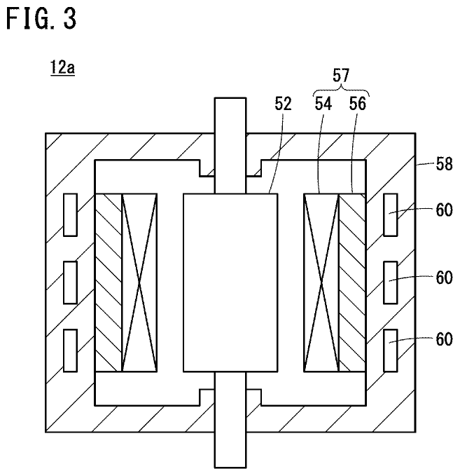

FIG. 2 is a block diagram showing a configuration of the cooling system 14 according to the first embodiment. FIG. 3 is a schematic view of the motor 12a. The cooling target 11 in the first embodiment is the motor 12a. The cooling system 14 includes a cooling device 16, a rotational speed sensor 18, a torque sensor 20, a temperature sensor 22, and a controller 24.

As shown in FIG. 2, the cooling device 16 includes a circulation flow path 26, a pump 28, a motor heat exchanger 30, a radiator 32, and an air blower 34. The cooling device 16 cools the motor 12a with a cooling medium. As shown in FIG. 3, the motor 12a described herein includes: a rotor 52 including magnets; and a stator 57 including windings 54 and a stator core 56. The rotor 52 and the stator 57 are accommodated in a housing 58. The rotor 52 is disposed at the center of the motor 12a. The stator 57 is disposed between the rotor 52 and the housing 58. A cooling flow path 60 is disposed in the housing 58. It should be noted that the cooling target of the cooling device 16 may be the motor 12a of another type.

Returning to FIG. 2, the cooling device 16 will be further described. The circulation flow path 26 includes a first pipe 26a, a second pipe 26b, and a third pipe 26c through which the cooling medium flows. The first pipe 26a allows a discharge outlet 28b of the pump 28 and an inlet 30a of the motor heat exchanger 30 to communicate with each other. The second pipe 26b allows an outlet 30b of the motor heat exchanger 30 and an inlet 32a of the radiator 32 to communicate with each other. The third pipe 26c allows an outlet 32b of the radiator 32 and a suction inlet 28a of the pump 28 to communicate with each other.

The pump 28 can impart flowability to the cooling medium in the circulation flow path 26. The pump 28 discharges, from the discharge outlet 28b, the cooling medium sucked from the suction inlet 28a. Specifically, the pump 28 circulates the cooling medium in the circulation flow path 26 in a direction indicated by the arrows in FIG. 2. The cooling medium discharged from the discharge outlet 28b of the pump 28 flows through the first pipe 26a and flows into the motor heat exchanger 30 from the inlet 30a.

The motor heat exchanger 30 includes the cooling flow path 60 (FIG. 3) through which the cooling medium flows. A first end portion of the cooling flow path 60 is connected to the inlet 30a of the motor heat exchanger 30. A second end portion of the cooling flow path 60 is connected to the outlet 30b of the motor heat exchanger 30. The motor heat exchanger 30 is disposed on the outer periphery of the motor 12a or inside the motor 12a. For example, the motor heat exchanger 30 may be a water jacket. As described above, the motor heat exchanger 30 of the present embodiment is disposed in the housing 58. The motor heat exchanger 30 performs heat exchange between the cooling medium and the motor 12a. Specifically, using the cooling medium, the motor heat exchanger 30 absorbs heat that is released from the motor 12a. The cooling medium that has flowed out from the outlet 30b of the motor heat exchanger 30 flows through the second pipe 26b and flows into the radiator 32 from the inlet 32a.

The radiator 32 includes a flow path (not shown) through which the cooling medium flows. A first end portion of the flow path of the radiator 32 is connected to the inlet 32a. The second end portion of the flow path of the radiator 32 is connected to the outlet 32b. The radiator 32 is disposed in the direction toward which the air blower 34 blows air. The radiator 32 performs heat exchange between the cooling medium and the outside air. That is, the radiator 32 releases the heat of the cooling medium to the outside air. The cooling medium that has flowed out from the outlet 32b of the radiator 32 flows through the third pipe 26c and is sucked into the pump 28 from the suction inlet 28a.

The air blower 34 is disposed in close proximity to the radiator 32. The air blower 34 blows air to the radiator 32 to cool the cooling medium flowing through the flow path of the radiator 32. The air blower 34 is operated by electric power supplied from a driver 40 of the controller 24.

The rotational speed sensor 18 detects the rotational speed of the motor 12a. Hereinafter, the rotational speed of the motor 12a is also simply referred to as a “rotational speed”. The rotational speed sensor 18 outputs an electric signal corresponding to the rotational speed of the motor 12a to the controller 24. The torque sensor 20 detects the torque of the motor 12a. Hereinafter, the torque of the motor 12a is also simply referred to as “torque”. The torque sensor 20 outputs an electric signal corresponding to the torque of the motor 12a to the controller 24.

The temperature sensor 22 detect the temperature of the cooling medium flowing from the outlet 32b of the radiator 32 to the inlet 30a of the motor heat exchanger 30. Hereinafter, the temperature detected by the temperature sensor 22 is also referred to as an “actual temperature (Tw)”. The temperature sensor 22 outputs an electric signal corresponding to the temperature of the cooling medium to the controller 24. It should be noted that, in order to cool the motor 12a, a control unit 44, which will be described later, performs feedback control of the air blower 34 based on the temperature of the cooling medium detected by the temperature sensor 22. Therefore, it is ideal that the temperature sensor 22 detects the temperature of the cooling medium at the inlet 30a of the motor heat exchanger 30. However, thermal disturbance that affects the temperature of the cooling medium may occur in the third pipe 26c, the pump 28, and the first pipe 26a. This thermal disturbance makes feedback control difficult. Therefore, from the viewpoint of ease of feedback control, the temperature sensor 22 preferably detects the temperature of the cooling medium at the outlet 32b of the radiator 32.

The controller 24 includes, for example, a computation section 36, a storage section 38, and the driver 40.

The computation section 36 may be constituted by a processor such as a central processing unit (CPU) or a graphics processing unit (GPU). That is, the computation section 36 can be constituted by processing circuitry.

The computation section 36 includes an acquisition unit 42 and the control unit 44. The acquisition unit 42 and the control unit 44 can be realized by the computation section 36 executing a program stored in the storage section 38.

At least part of the acquisition unit 42 and the control unit 44 may be realized by an integrated circuit such as an application specific integrated circuit (ASIC) or a field-programmable gate array (FPGA). Further, at least part of the acquisition unit 42 and the control unit 44 may be constituted by an electronic circuit including a discrete device.

The acquisition unit 42 acquires information input to the control unit 44. Specifically, the acquisition unit 42 acquires information about the torque of the motor 12a based on the electric signal output from the torque sensor 20. The acquisition unit 42 acquires information about the rotational speed of the motor 12a based on the electric signal output from the rotational speed sensor 18. The acquisition unit 42 acquires information about the temperature (Tw) of the cooling medium based on the electric signal output from the temperature sensor 22. Note that an external system other than the cooling system 14 may generate command values related to the information about the torque of the motor 12a, the information about the rotational speed of the motor 12a, and the information about the temperature of the cooling medium. In such a case, the acquisition unit 42 may acquire the command values from the external system.

The control unit 44 controls the air blower 34 based on the various types of information acquired by the acquisition unit 42. The control unit 44 performs feedforward control and feedback control based on the information about the torque of the motor 12a, the information about the rotational speed of the motor 12a, and the information about the temperature of the cooling medium, and generates a control signal for the air blower 34. The control unit 44 outputs the generated control signal to the driver 40.

The storage section 38 may be constituted by a volatile memory (not shown) and a non-volatile memory (not shown). Examples of the volatile memory can include a random access memory (RAN). The volatile memory is used as a working memory of the processor and temporarily stores data and the like required for processing or computation. Examples of the non-volatile memory can include a read only memory (ROM) and a flash memory. The non-volatile memory is used as a storage memory and stores programs, tables, maps, and the like. At least part of the storage section 38 may be included in the processor, the integrated circuit, or the like described above.

The non-volatile memory stores a winding temperature map 46, and a heat generation amount map 48. The winding temperature map 46 associates the rotational speed of the motor 12a, the torque of the motor 12a, and a target winding temperature (Tc_t) with each other. The target winding temperature (Tc_t) is a target value of the winding temperature at which the loss (copper loss, iron loss, mechanical loss) is minimized for the combination of the rotational speed and the torque. Note that the winding temperature map 46 may associate the rotational speed of the motor 12a, the torque of the motor 12a, the outside air temperature, and the target winding temperature (Tc_t) with each other. The heat generation amount map 48 associates, with each other, the rotational speed of the motor 12a, the torque of the motor 12a, and heat generation amounts (Qr, Qc, and Qs) of the respective components (the rotor 52, the windings 54, and the stator core 56) of the motor 12a. The heat generation amount map 48 and the winding temperature map 46 are created in advance based on experimental results or simulation results.

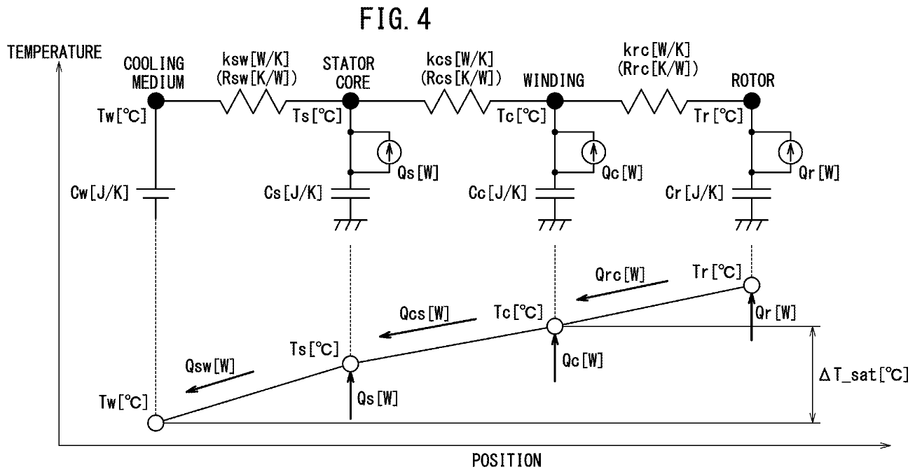

The non-volatile memory further stores a thermal model 50 of the motor 12a. FIG. 4 is an explanatory diagram for explaining the thermal model 50 of the motor 12a. The thermal model 50 (also referred to as thermal model information) is information that enables estimation of a heat transfer phenomenon inside the motor 12a by replacing the heat transfer phenomenon with an electric circuit model. The thermal model 50 of the present embodiment is information in which the operating point of the motor 12a and the temperature of each component of the motor 12a in a thermally saturated state are associated with each other. The operating point of the motor 12a includes the rotational speed and the torque. The thermally saturated state is a temperature state of the motor 12a whose temperature change has converged. In other words, the thermally saturated state is a temperature state of the motor 12a when the motor 12a is operated for an infinite time at a constant operating point.

In the motor 12a, the respective components (the rotor 52, the windings 54, and the stator core 56) generate heat. As shown in FIG. 4, the temperature of each component increases in accordance with the heat capacity thereof. In the motor 12a, heat is conducted from each component toward the cooling medium. The amount of heat transfer between the components is determined by the temperature difference between the components and the thermal resistance between the components. The characters shown in FIG. 4 are as follows.
Qr: heat generation amount [W] of rotor 52
Qc: heat generation amount [W] of windings 54
Qs: heat generation amount [W] of stator core 56
Tr: temperature [° C.] of rotor 52
Tc: temperature [° C.] of windings 54
Ts: temperature [° C.] of stator core 56
Tw: temperature [° C.] of cooling medium
Cr: heat capacity [J/K] of rotor 52
Cc: heat capacity [J/K] of windings 54
Cs: heat capacity [J/K] of stator core 56
krc: thermal conductance [W/K] between rotor 52 and windings 54
kcs: thermal conductance [W/K] between windings 54 and stator core 56
ksw: thermal conductance [W/K] between stator core 56 and cooling medium
Rrc: thermal resistance [K/W] between rotor 52 and windings 54
Rcs: thermal resistance [K/W] between windings 54 and stator core 56
Rsw: thermal resistance [K/W] between stator core 56 and cooling medium
Qrc: amount of heat transfer [W] between rotor 52 and windings 54
Qcs: amount of heat transfer [W] between windings 54 and stator core 56
Qsw: amount of heat transfer [W] between stator core 56 and cooling medium

The state equation of the one dimensional thermal model 50 shown in FIG. 4 is expressed by the following Equation (1).

$$( \begin{matrix}Cs & 0 & 0 \\ 0 & Cc & 0 \\ 0 & 0 & Cr\end{matrix} ) \frac{d}{dt} ( \begin{matrix}Ts \\ Tc \\ Tr\end{matrix} ) = ( \begin{matrix}- ksw - kcs & krc & 0 \\ 0 & - kcs - krc & krc \\ 0 & krc & - krc\end{matrix} ) ( \begin{matrix}Ts \\ Tc \\ Tr\end{matrix} ) + ( \begin{matrix}Qs \\ Qc \\ Qr\end{matrix} ) + ( \begin{matrix}ksw \\ 0 \\ 0\end{matrix} ) Tw \qquad Equation ( 1 )$$

The state equation of the motor 12a brought into the thermally saturated state is expressed by the following Equation (2).

$$0 = ( \begin{matrix}- ksw - kcs & kcs & 0 \\ 0 & - kcs - krc & krc \\ 0 & krc & - krc\end{matrix} ) ( \begin{matrix}Ts \\ Tc \\ Tr\end{matrix} ) + ( \begin{matrix}Qs \\ Qc \\ Qr\end{matrix} ) + ( \begin{matrix}ksw \\ 0 \\ 0\end{matrix} ) Tw \qquad Equation ( 2 )$$

The above Equation (2) can be modified as follows.

$$\begin{matrix}( \begin{matrix}Ts \\ Tc \\ Tr\end{matrix} ) = ( \begin{matrix}- ksw & kcs & 0 \\ kcs & - kcs - krc & krc \\ 0 & krc & - krc\end{matrix} ) \times ( \begin{matrix}Qs + kswTw \\ Qc \\ Qr\end{matrix} ) \\ = - {( K )}^{- 1} \times ( \begin{matrix}Qs \\ Qc \\ Qr\end{matrix} ) - {( K )}^{- 1} \times ( \begin{matrix}kswTw \\ 0 \\ 0\end{matrix} ) \\ = - {( K )}^{- 1} \times ( \begin{matrix}Qs \\ Qc \\ Qr\end{matrix} ) + ( \begin{matrix}Tw \\ Tw \\ Tw\end{matrix} )\end{matrix}$$

In the above Equation (3), the inverse matrix is represented by “(K)⁻¹”.

The non-volatile memory may store any one of the above Equations (1) to (3) as the thermal model 50. Alternatively, the non-volatile memory may store another thermal model 50. Further, the non-volatile memory stores each thermal conductance (krc, kcs, ksw) in advance. Note that the thermal model 50 is determined according to the type of the motor 12a.

The driver 40 shown in FIG. 2 is a drive circuit for the air blower 34. The driver 40 supplies, to the air blower 34, electric power corresponding to a control signal generated by the control unit 44 of the controller 24.

### [2-2. Operation of Cooling System 14]

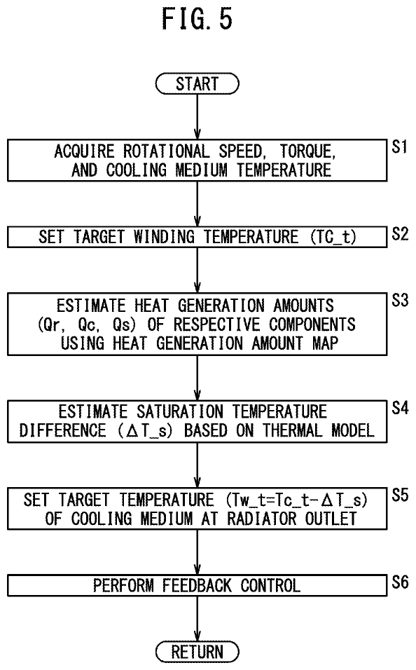

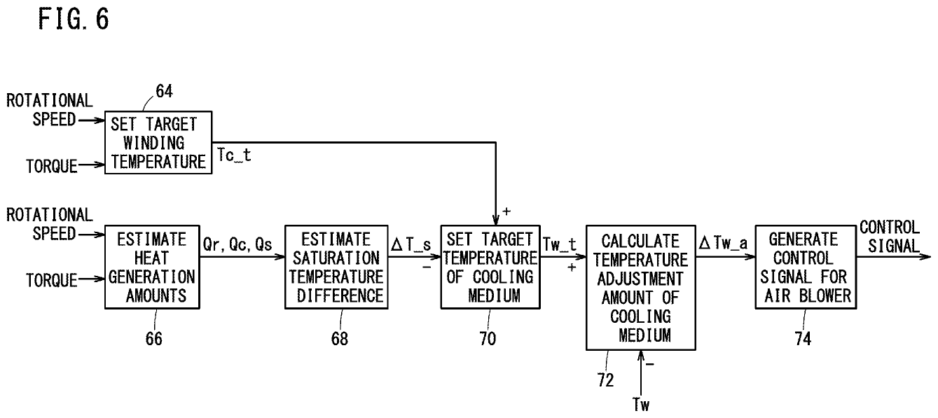

FIG. 5 is a flowchart of a cooling process according to the first embodiment. FIG. 6 is a block diagram of feedforward control and feedback control according to the first embodiment. The computation section 36 executes the process shown in FIG. 5 at predetermined time intervals.

In step S1, the acquisition unit 42 acquires the rotational speed of the motor 12a based on the electric signal output from the rotational speed sensor 18. The acquisition unit 42 acquires the torque of the motor 12a based on the electric signal output from the torque sensor 20. The acquisition unit 42 acquires the temperature of the cooling medium at the outlet 32b of the radiator 32 based on the electric signal output from the temperature sensor 22. The temperature of the cooling medium acquired from the temperature sensor 22 is referred to as the actual temperature (Tw) of the cooling medium.

In step S2, the control unit 44 sets the target winding temperature (Tc_t). The process of step S2 corresponds to the control of a first target setting block 64 in the block diagram (FIG. 6). Here, the control unit 44 uses the winding temperature map 46 to acquire the target winding temperature (Tc_t) corresponding to the rotational speed and the torque. The target winding temperature (Tc_t) may be a constant value instead of a variable value determined according to the rotational speed and the torque. When the target winding temperature (Tc_t) is a constant value, the target winding temperature (Tc_t) is stored in the storage section 38 in advance.

In step S3, the control unit 44 estimates the heat generation amounts (Qr, Qc, Qs) of the respective components. The process of step S3 corresponds to the control of a heat generation amount estimation block 66 in the block diagram (FIG. 6). Here, the control unit 44 uses the heat generation amount map 48 to acquire the heat generation amounts (Qr, Qc, Qs) of the respective components (the rotor 52, the windings 54, and the stator core 56) of the motor 12a corresponding to the rotational speed and the torque.

In step S4, the control unit 44 estimates a saturation temperature difference (ΔT_s). The process of step S4 corresponds to the control of a temperature difference estimation block 68 in the block diagram (FIG. 6). The saturation temperature difference (ΔT_s) is a temperature difference between predetermined components inside the motor 12a in a thermally saturated state. Here, the control unit 44 calculates the temperatures (Tr, Tc, Ts) of the respective components based on the heat generation amounts (Qr, Qc, Qs) of the respective components estimated in the heat generation amount estimation block 66, the respective thermal conductances (krc, kcs, ksw) stored in the storage section 38, and the above Equation (3). Further, the control unit 44 estimates the temperature difference between the windings 54 and the cooling medium as the saturation temperature difference (ΔT_s=Tc −Tw).

In step S5, the control unit 44 sets a target temperature (Tw_t) of the cooling medium at the outlet 32b of the radiator 32. Step S5 is a process of setting the target temperature (Tw_t) of the cooling medium in consideration of the temperature rise of the cooling medium in the motor 12a. The process of step S5 corresponds to the control of a second target setting block 70 in the block diagram (FIG. 6). Here, the control unit 44 subtracts the saturation temperature difference (ΔT_s) from the target winding temperature (Tc_t) to acquire the target temperature (Tw_t) of the cooling medium at the outlet 32b of the radiator 32.

In step S6, the control unit 44 performs feedback control. Here, the control unit 44 subtracts the actual temperature (Tw) of the cooling medium acquired in step S1 from the target temperature (Tw_t) of the cooling medium to calculate a temperature adjustment amount (ΔTw_a). (This process corresponds to an adjustment amount calculation block 72 in FIG. 6.) Further, the control unit 44 generates a control signal for the air blower 34 based on the temperature adjustment amount (ΔTw_a) of the cooling medium. The control unit 44 outputs the control signal for the air blower 34 to the driver 40. (This process corresponds to a signal output block 74 in FIG. 6.)

As described above, the control unit 44 performs the feedforward control based on the rotational speed and the torque acquired by the acquisition unit 42, and generates a feedforward value (Tw_t). The first target setting block 64, the heat generation amount estimation block 66, the temperature difference estimation block 68, and the second target setting block 70 shown in FIG. 6 constitute the feedforward control. Further, the control unit 44 performs feedback control to bring the actual temperature (Tw) of the cooling medium close to the target temperature (Tw_t) of the cooling medium, which is the feedforward value. The adjustment amount calculation block 72 and the signal output block 74 shown in FIG. 6 constitute the feedback control.

The driver 40 operates the air blower 34 in accordance with the control signal output from the computation section 36 (control unit 44). The cooling medium flowing through the radiator 32 dissipates heat to the outside air and is cooled by the air blown by the air blower 34. The cooling medium flowing out from the outlet 32b of the radiator 32 flows through the third pipe 26c, the pump 28, and the first pipe 26a, and flows into the motor heat exchanger 30. The cooling medium flowing through the motor heat exchanger 30 absorbs heat from the motor 12a, thereby cooling the motor 12a. The cooling medium flowing out from the outlet 30b of the motor heat exchanger 30 flows through the second pipe 26b and flows into the radiator 32.

For example, when the rotational speed of the motor 12a is high, the loss of the windings 54 is small, and the loss of the stator core 56 formed from an electromagnetic steel sheet or the like is large. On the other hand, when the rotational speed of the motor 12a is low, the loss of the stator core 56 is small, and the loss of the windings 54 is large. Further, a heat generating portion of the motor 12a varies depending on the rotational speed and the torque. That is, the heat generating state of the motor 12a varies depending on the rotational speed and the torque. In response to this situation, according to the first embodiment, a feedforward value is generated using the rotational speed and the torque of the motor 12a, and feedback control is performed using the feedforward value. In this manner, according to the first embodiment, since the rotational speed and the torque of the motor 12a are reflected in the cooling control, the accuracy of the cooling control can be improved.

### 3. Modification of First Embodiment

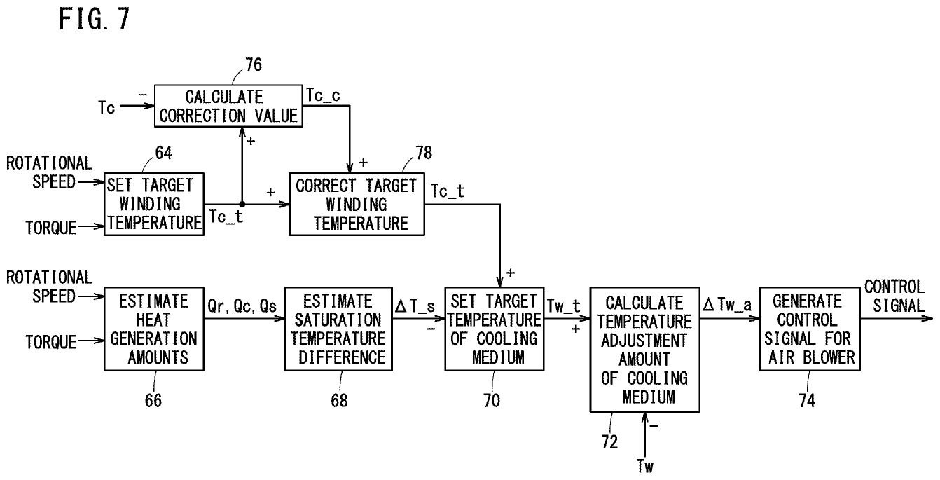

FIG. 7 is a block diagram of feedforward control and feedback control according to a modification of the first embodiment. As shown in FIG. 7, the control unit 44 may use the feedback control to correct the target winding temperature (Tc_t), which is an input value of the second target setting block 70.

In a correction value calculation block 76, the control unit 44 subtracts an actual temperature (Tc) of the windings 54 of the motor 12a from the target winding temperature (Tc_t) set in the first target setting block 64. Thus, the control unit 44 acquires a correction value (Tc_c) of the target winding temperature (Tc_t). The actual temperature (Tc) of the windings 54 of the motor 12a is detected by, for example, a sensor (not shown).

In a correction block 78, the control unit 44 adds the correction value (Tc_c) to the target winding temperature (Tc_t) set in the first target setting block 64. The control unit 44 newly sets the value obtained by the addition, as the corrected target winding temperature (Tc_t).

### 4. Second Embodiment

### [4-1. Configuration of Cooling System 14]

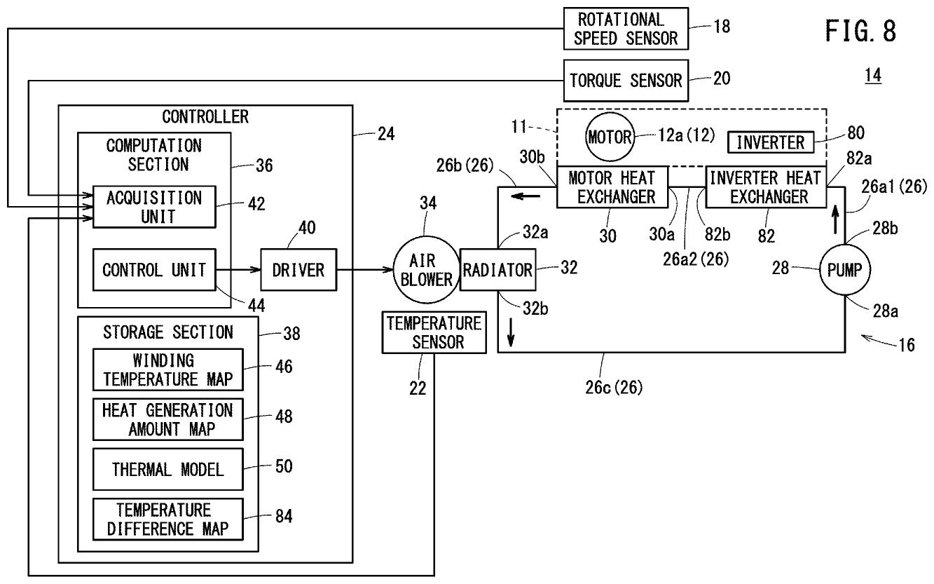

FIG. 8 is a block diagram showing a configuration of the cooling system 14 according to the second embodiment. In the second embodiment, the same components as those in the first embodiment are denoted by the same reference numerals, and the description thereof will be omitted. The cooling target 11 in the second embodiment is the motor 12a and an inverter 80. The inverter 80 controls electric power supplied to the motor 12a in accordance with a control signal output from a motor controller (not shown). The cooling device 16 according to the second embodiment includes an inverter heat exchanger 82, in addition to the respective components of the cooling device 16 according to the first embodiment.

The heat generation amount of the inverter 80 is lower than the heat generation amount of the motor 12a. In order to efficiently cool the inverter 80 and the motor 12a with the cooling medium flowing through the closed circuit, the cooling medium preferably absorbs heat from the inverter 80 and then absorbs heat from the motor 12a. Therefore, the inverter heat exchanger 82 is disposed downstream of the radiator 32 and upstream of the motor heat exchanger 30. For example, the inverter heat exchanger 82 is connected to the pump 28 via a first pipe 26al. Further, the inverter heat exchanger 82 is connected to the motor heat exchanger 30 via a first pipe 26a2.

The inverter heat exchanger 82 includes a flow path (not shown) through which the cooling medium flows. A first end portion of the flow path is connected to an inlet 82a of the inverter heat exchanger 82. A second end portion of the flow path is connected to an outlet 82b of the inverter heat exchanger 82. The inlet 82a is connected to the first pipe 26al. The outlet 82b is connected to the first pipe 26a2. The inverter heat exchanger 82 performs heat exchange between the cooling medium and the inverter 80. Specifically, using the cooling medium, the inverter heat exchanger 82 absorbs heat that is released from the inverter 80. The cooling medium that has flowed out from the outlet 82b of the inverter heat exchanger 82 flows through the first pipe 26a2 and flows into the motor heat exchanger 30 from the inlet 30a.

The non-volatile memory of the storage section 38 stores a temperature difference map 84. The temperature difference map 84 associates, with each other, the rotational speed of the motor 12a, the torque of the motor 12a, and the temperature difference between the inlet 82a and the outlet 82b of the inverter heat exchanger 82. This temperature difference is the temperature difference between the inlet 82a and the outlet 82b of the inverter heat exchanger 82 when the motor 12a is in the thermally saturated state. The temperature difference map 84 is created in advance based on experimental results or simulation results.

### [4-2. Operation of Cooling System 14]

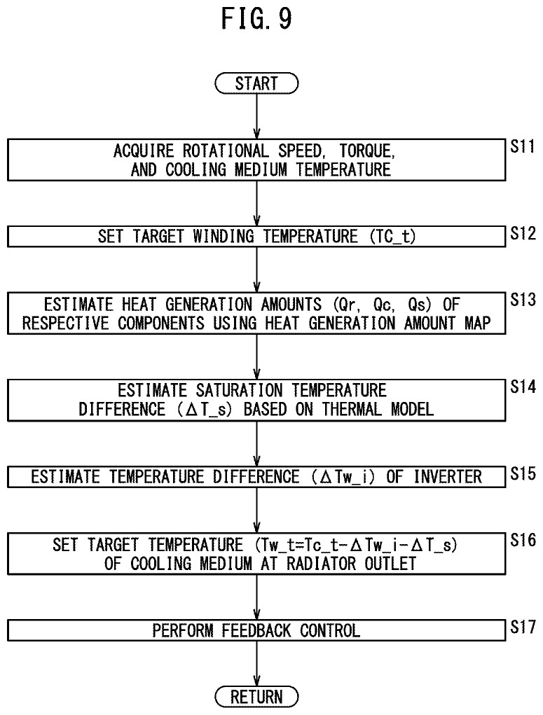

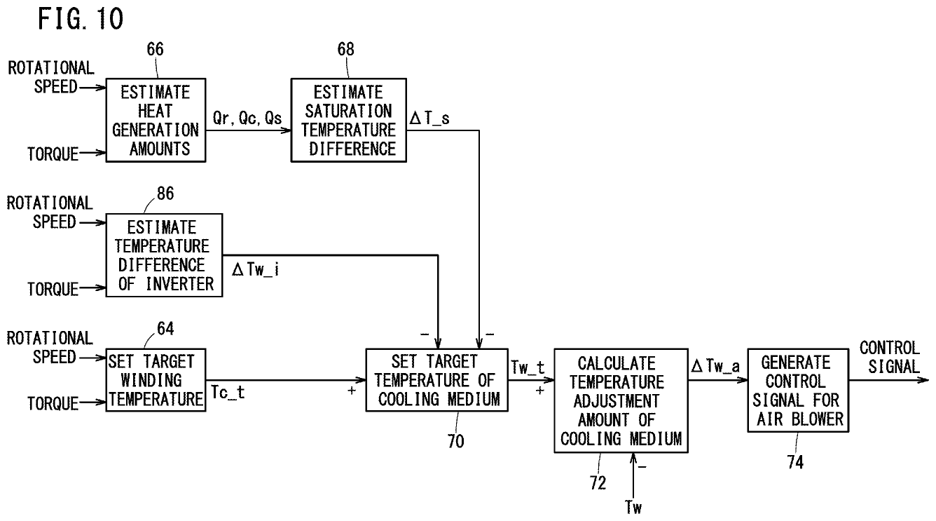

FIG. 9 is a flowchart of a cooling process according to the second embodiment. FIG. 10 is a block diagram of feedforward control and feedback control according to the second embodiment. The computation section 36 executes the process shown in FIG. 9 at predetermined time intervals. The processes of steps S11 to S14 and S17 shown in FIG. 9 are substantially the same as the processes of steps S1 to S4 and S6 shown in FIG. 5. Further, the block diagram shown in FIG. 10 is the same as the block diagram shown in FIG. 6 except for a second temperature difference estimation block 86. Hereinafter, regarding the process of the second embodiment, processing different from that of the first embodiment will be described.

In step S15, the control unit 44 estimates a temperature difference (ΔTw_i) of the inverter 80. The process of step S15 corresponds to the control of the second temperature difference estimation block 86 in the block diagram (FIG. 10). Here, the control unit 44 uses the temperature difference map 84 to acquire the temperature difference (ΔTw_i) between the inlet 82a and the outlet 82b of the inverter heat exchanger 82 corresponding to the rotational speed and the torque.

In step S16, the control unit 44 sets the target temperature (Tw_t) of the cooling medium at the outlet 32b of the radiator 32. Step S16 is a process of setting the target temperature (Tw_t) of the cooling medium in consideration of the temperature rise of the cooling medium in the inverter 80 and the motor 12a. The process of step S16 corresponds to the control of the second target setting block 70 in the block diagram (FIG. 10). Here, the control unit 44 subtracts the temperature difference (ΔTw_i) and the saturation temperature difference (ΔT_s) from the target winding temperature (Tc_t) to acquire the target temperature (Tw_t) of the cooling medium at the outlet 32b of the radiator 32.

According to the second embodiment, the motor 12a and the inverter 80 can be cooled by the single cooling device 16.

### 5. First Modification of Second Embodiment

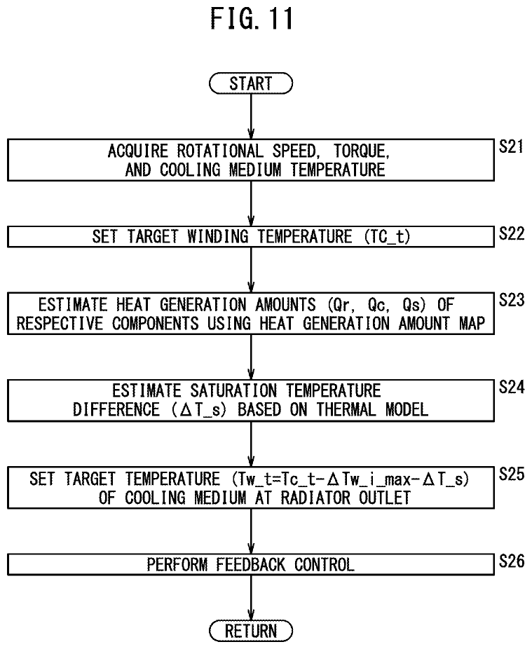

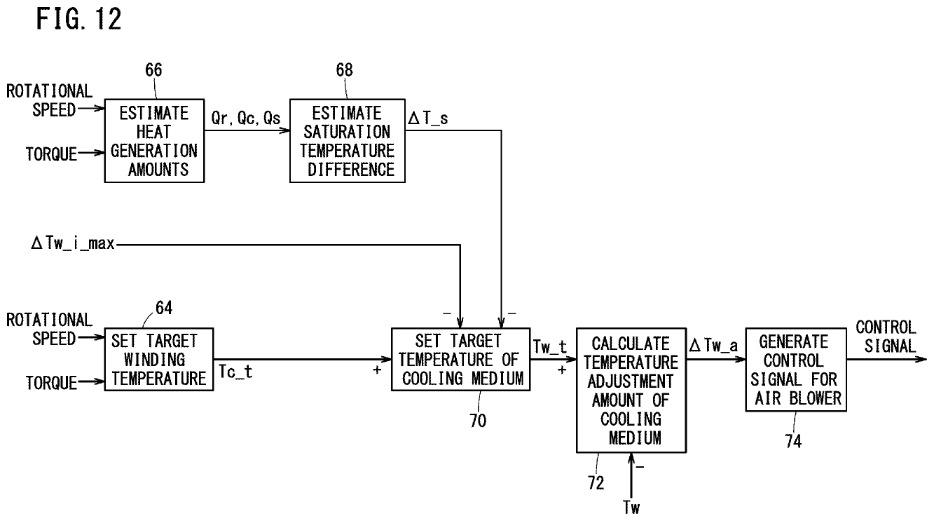

FIG. 11 is a flowchart of a cooling process according to a first modification of the second embodiment. FIG. 12 is a block diagram of feedforward control and feedback control according to the first modification of the second embodiment. The computation section 36 executes the process shown in FIG. 11 at predetermined time intervals. The processes of step S21 to S24 and S26 shown in FIG. 11 are substantially the same as the processes of steps S11 to S14 and S17 shown in FIG. 9.

In the first modification, a maximum increased temperature (ΔTw_i_max) of the inverter 80 is used instead of the temperature difference (ΔTw_i) of the inverter 80 used in the second embodiment. The maximum increased temperature (ΔTw_i_max) of the inverter 80 is the maximum temperature to which the temperature of the cooling medium can rise in the inverter heat exchanger 82. The maximum increased temperature (ΔTw_i_max) is stored in the storage section 38 in advance.

In the first modification, the control unit 44 performs the process of step S25 instead of step S15 and step S16 in the second embodiment. In step S25, the control unit 44 subtracts the maximum increased temperature (ΔTw_i_max) and the saturation temperature difference (ΔT_s) from the target winding temperature (Tc_t) to acquire the target temperature (Tw_t) of the cooling medium at the outlet 32b of the radiator 32. The process of step S25 corresponds to the control of the second target setting block 70 in the block diagram (FIG. 12).

According to the first modification of the second embodiment, the process is made simpler than that of the second embodiment. Therefore, the processing speed of the computation section 36 can be increased.

### 6. Second Modification of Second Embodiment

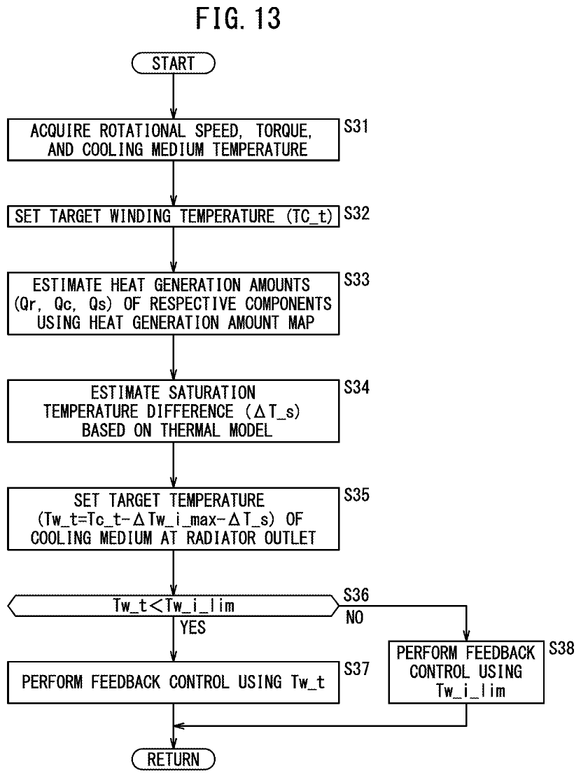

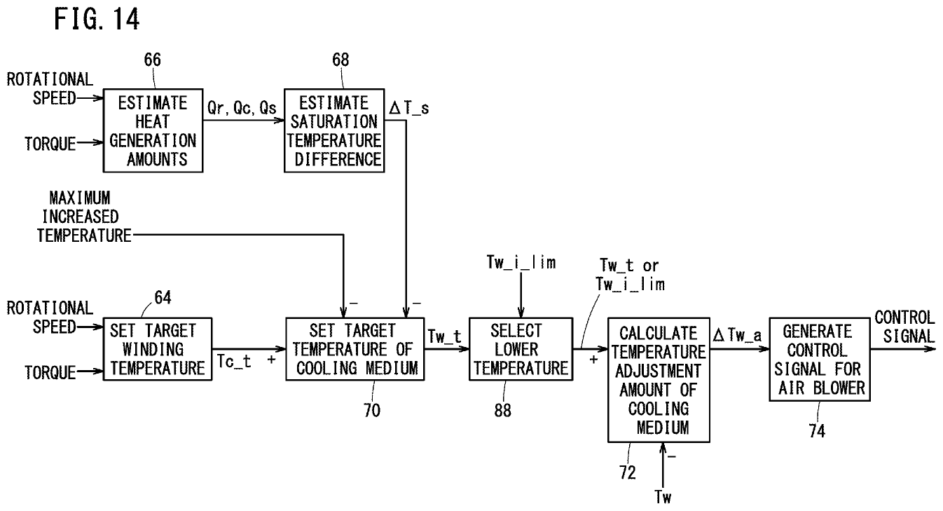

FIG. 13 is a flowchart of a cooling process according to a second modification of the second embodiment. FIG. 14 is a block diagram of feedforward control and feedback control according to the second modification of the second embodiment. The computation section 36 executes the process shown in FIG. 13 at predetermined time intervals. The processes of steps S31 to S35 shown in FIG. 13 are substantially the same as the processes of steps S21 to S25 shown in FIG. 11.

The second modification is a modification in which the first modification of the second embodiment is further modified. In the second modification, a limit temperature (Tw_i_lim) of the temperature of the cooling medium is used. The limit temperature (Tw_i_lim) is an upper limit of the allowable temperature of the cooling medium at the inlet 82a of the inverter heat exchanger 82. That is, the limit temperature (Tw_i_lim) is a temperature for protecting the inverter 80. The limit temperature (Tw_i_lim) is stored in the storage section 38 in advance.

In step S36, the control unit 44 compares the target temperature (Tw_t) of the cooling medium at the outlet 32b of the radiator 32 as set in step S35 with the limit temperature (Tw_i_lim) stored in advance. In a case where the target temperature (Tw_t) is lower than the limit temperature (Tw_i_lim) (step S36: YES), the control unit 44 selects the target temperature (Tw_t), and the process proceeds to step S37. On the other hand, in case where the limit temperature (Tw_i_lim) is lower than the target temperature (Tw_t) or in a case where both temperatures are equal to each other (step S36: NO), the control unit 44 selects the limit temperature (Tw_i_lim), and the process proceeds to step S38. In this manner, the control unit 44 selects the lower one of the target temperature (Tw_t) and the limit temperature (Tw_i_lim). The process of step S36 corresponds to the control of a temperature selection block 88 in the block diagram (FIG. 14).

When the process proceeds from step S36 to step S37, the control unit 44 performs feedback control using the target temperature (Tw_t). Here, the control unit 44 subtracts the actual temperature (Tw) of the cooling medium from the target temperature (Tw_t) of the cooling medium to calculate the temperature adjustment amount (ΔTw_a). (This process corresponds to the adjustment amount calculation block 72 in FIG. 14.) Further, the control unit 44 generates a control signal for the air blower 34 based on the temperature adjustment amount (ΔTw_a) of the cooling medium. The control unit 44 outputs the control signal for the air blower 34 to the driver 40. (This process corresponds to the signal output block 74 in FIG. 14.)

When the process proceeds from step S36 to step S38, the control unit 44 performs feedback control using the limit temperature (Tw_i_lim). Here, the control unit 44 subtracts the actual temperature (Tw) of the cooling medium from the limit temperature (Tw_i_lim) of the cooling medium to calculate the temperature adjustment amount (ΔTw_a). (This process corresponds to the adjustment amount calculation block 72 in FIG. 14.). Further, the control unit 44 generates a control signal for the air blower 34 based on the temperature adjustment amount (ΔTw_a) of the cooling medium. The control unit 44 outputs the control signal for the air blower 34 to the driver 40. (This process corresponds to the signal output block 74 in FIG. 14.)

According to the second modification of the second embodiment, since the temperature of the cooling medium supplied to the inverter heat exchanger 82 is set to be equal to or lower than the limit temperature (Tw_i_lim), the inverter 80 can be protected.

### 7. Others

The present invention is not limited to the above disclosure, and various modifications are possible without departing from the essence and gist of the present invention.

For example, the flight mode of the eVTOL aircraft includes a mode corresponding to a flight state such as vertical takeoff, cruising, vertical landing, or hovering, and a mode corresponding to a transition between the flight states. The control unit 44 may correct the target winding temperature (Tc_t) or the target temperature (Tw_t) of the cooling medium based on the flight mode.

### 8. Appendices

The following notes (appendices) are further disclosed in relation to the above-described embodiment.

### (Appendix 1)

The cooling system (14) is a cooling system that cools the cooling target (11) including the rotating electric machine (12), and includes: the acquisition unit (42) configured to acquire information about the rotational speed of the rotating electric machine and information about the torque of the rotating electric machine; the cooling device (16) configured to cool the cooling target; and the control unit (44) configured to control the cooling device based on the feedforward value (Tw_t) generated based on the rotational speed and the torque. According to such a configuration, since the rotational speed and the torque of the motor (12a) are reflected in the cooling control, the accuracy of the cooling control can be improved.

### (Appendix 2)

In the cooling system according to Appendix 1, the cooling device may include the pump (28) configured to circulate the cooling medium that absorbs heat released from the rotating electric machine, the radiator (32) configured to release heat of the cooling medium, and the air blower (34) configured to blow air to the radiator, and the feedforward value may be the target temperature of the cooling medium supplied from the radiator to the rotating electric machine.

### (Appendix 3)

In the cooling system according to Appendix 2, the acquisition unit may further acquire the information indicating the actual temperature (Tw) of the cooling medium supplied from the radiator to the rotating electric machine, and the control unit may control the air blower to bring the actual temperature closer to the target temperature by performing feedback control using the actual temperature.

### (Appendix 4)

In the cooling system according to Appendix 1, the control unit may generate the feedforward value based on the rotational speed, the torque, and the thermal model (50) of the rotating electric machine that is in the thermally saturated state in which the temperature change thereof has converged.

### (Appendix 5)

In the cooling system according to Appendix 4, the cooling device may include the pump configured to circulate the cooling medium that absorbs heat released from the rotating electric machine, the radiator configured to release heat of the cooling medium, and the air blower configured to blow air to the radiator, the control unit may calculate the temperature difference (ΔT_s) between the temperature of the windings (54) of the rotating electric machine in the thermally saturated state and the temperature of the cooling medium in the thermally saturated state, based on the rotational speed, the torque, and the thermal model, and subtract the temperature difference from the predetermined target temperature (Tc_t) of the windings to generate the feedforward value.

### Appendix 6

In the cooling system according to Appendix 5, the control unit may estimate the heat generation amount (Qr, Qc, Qs) of the windings based on the rotational speed, the torque, and the map (48) in which the heat generation amount of the windings is associated with the rotational speed and the torque.

### Appendix 7

In the cooling system according to any one of Appendices 2, 3, 5, and 6, the feedforward value may be the target temperature of the cooling medium at the outlet (32b) of the radiator. According to such a configuration, it is possible to reduce the influence of thermal disturbance on the cooling medium cooled by the radiator. Therefore, feedback control is facilitated.

### Appendix 8

The moving object (10) includes the cooling system according to any one of Appendices 1 to 7.

1. A cooling system comprising:
a cooling device configured to cool a cooling target including a rotating electric machine; and
one or more processors that execute computer-executable instructions stored in a memory,
wherein the one or more processors execute the computer-executable instructions to cause the cooling system to:
acquire information about a rotational speed of the rotating electric machine, and information about torque of the rotating electric machine; and
control the cooling device based on a feedforward value generated based on the rotational speed and the torque.

2. The cooling system according to claim 1, wherein
the cooling device includes:
a pump configured to circulate a cooling medium that absorbs heat released from the rotating electric machine;
a radiator configured to release heat of the cooling medium; and
an air blower configured to blow air to the radiator, and
the feedforward value is a target temperature of the cooling medium supplied from the radiator to the rotating electric machine.

3. The cooling system according to claim 2, wherein
the one or more processors cause the cooling system to:
further acquire information indicating an actual temperature of the cooling medium supplied from the radiator to the rotating electric machine; and
control the air blower to bring the actual temperature closer to the target temperature by performing feedback control using the actual temperature.

4. The cooling system according to claim 1, wherein
the one or more processors cause the cooling system to generate the feedforward value based on the rotational speed, the torque, and a thermal model of the rotating electric machine that is in a thermally saturated state in which a temperature change of the rotating electric machine has converged.

5. The cooling system according to claim 4, wherein
the cooling device includes:
a pump configured to circulate a cooling medium that absorbs heat released from the rotating electric machine;
a radiator configured to release heat of the cooling medium; and
an air blower configured to blow air to the radiator, and
the one or more processors cause the cooling system to:
calculate a temperature difference between a temperature of windings of the rotating electric machine in the thermally saturated state and a temperature of the cooling medium in the thermally saturated state, based on the rotational speed, the torque, and the thermal model; and
subtract the temperature difference from a predetermined target temperature of the windings to generate the feedforward value.

6. The cooling system according to claim 5, wherein
the one or more processors cause the cooling system to estimate a heat generation amount of the windings based on the rotational speed, the torque, and a map in which the heat generation amount of the windings is associated with the rotational speed and the torque.

7. The cooling system according to claim 2, wherein
the feedforward value is the target temperature of the cooling medium at an outlet of the radiator.

8. A moving object comprising the cooling system according to claim 1.
